(19) United States
(12) Patent Application Publication
(10) Pub. No.: US 2002/0023193 A1
(43) Pub. Date: Feb. 21, 2002

(54) Semiconductor memory and address controlling method thereof

(75) Inventor: Masatsugu Nakamura, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/855,243

(22) Filed: May 15, 2001

(30) Foreign Application Priority Data
May 18, 2000 (JP) 152725/2000

(51) Int. Cl. G06F 12/00

(52) U.S. Cl. 711/106

(57) ABSTRACT

A semiconductor memory and an address controlling method of the semiconductor memory, in which all of the word lines of the semiconductor memory are refreshed equally and a row address strobe only refreshing (ROR) process is not required after a self refreshing process, are provided. When the semiconductor memory is instructed to change to a self refreshing mode from the outside, an external address right before the mode is changed to the self refreshing mode is latched at a latch circuit. And “1” is added to the latched external address and this added “1” external address is made to be a first internal address. And a counter counts the internal address from the first internal address and the internal address is moved around. And when the internal address moved around became equal to the latched external address, the self refreshing mode is ended.

### BACKGROUND OF THE INVENTION

The present invention relates to a semiconductor memory having a self refreshing function and an address controlling method thereof.

### DESCRIPTION OF THE RELATED ART

At a dynamic random access memory (DRAM), when an electric charge is not applied to the DRAM in a certain interval, the memorized data are erased because of its structure. In order to avoid this, a memory controller reads out the memorized data from the DRAM, or a refreshing process signifying that an electric charge is applied to the DRAM every designated time is executed. At the DRAM, when one row in row addresses is selected by an address that is taken by the down edge of a row address strobe (RAS) # signal, all of the memory cells in a column belonging to the row are refreshed.

One of the refreshing methods is a self refreshing method. At the self refreshing method, the DRAM is refreshed by its own refreshing circuit, not depending on an external refreshing circuit. And the power consumption can be largely reduced by this self refreshing method, and generally this self refreshing method is applied to a note type personal computer (PC) and a laptop type PC.

FIG. 1 is a timing chart showing the operation of an internal address generating circuit of a semiconductor memory at a conventional technology. As shown in FIG. 1, when the mode was changed to a self refreshing mode, the addresses are changed to internal addresses from external addresses. At this time, a using internal address “n” is decided by an address of an internal counter and the using internal address can not be known from the outside. At the conventional technology, a CPU controls the end of the self refreshing process and the self refreshing process is ended by that the RAS # signal and the column address strobe (CAS) # signal become high, that is, by that a read/write command is inputted from the CPU.

The Japanese Patent Application Laid-Open No. HEI 11-242884 discloses an address controlling circuit for a semiconductor memory. At this application, only when the discontinuity of address occurs at an address counter, the address controlling circuit executes a RAS only refresh (ROR) process multiplexed on an actual access during the period that the address is moved around once from the discontinuity point.

However, at the conventional technology shown in FIG. 1, the CPU makes the self refreshing process end without considering until what word line is refreshed. Therefore, after the self refreshing process, a centralized refreshing process is applied to all of the word lines by the ROR. However, this ROR process after the self refreshing process is wasteful.

During the self refreshing process, it can not be recognized whether the address of the internal counter moved around once or not, and the CPU stops the self refreshing process by compulsion. This is the reason why the centralized refreshing process is executed after the self refreshing process. Consequently, the number of refreshing times is different among addresses, and all of the word lines are not refreshed equally, and some word lines are held in a long time. Therefore, in order to avoid this long hold, after the self refreshing process, the centralized refreshing process, that is, the ROR process is executed.

### SUMMARY OF THE INVENTION

It is therefore an object of the present invention to provide a semiconductor memory in which an ROR process is not needed after a self refreshing process and an address controlling method to execute this self refreshing process in the semiconductor memory.

According to a first aspect of the present, for achieving the object mentioned above, there is provided a semiconductor memory. The semiconductor memory provides a first counting means for counting internal addresses when the semiconductor memory was instructed to change to a self refreshing mode, and an internal address detecting means for detecting whether the internal address moved around once or not by the counted result at the first counting means. And the internal address detecting means makes the self refreshing mode end when the internal address detecting means detected that the internal address had moved around once by the counted result at the first counting means.

According to a second aspect of the present invention, there is provided a semiconductor memory. The semiconductor memory provides a latch means for latching external addresses inputted from the outside when the semiconductor memory was instructed to change to a self refreshing mode, an adding means for adding “1” to a last external address in the external addresses latched at the latch means, a second counting means for counting internal addresses at designated timing by making the last external address added “1” be a first internal address so that the internal address moves around once, and a comparing means for comparing the internal addresses counted by the second counting means with the last external address latched at the latch means. And the comparing means makes the self refreshing mode end, when one of the internal addresses counted by the second counting means became equal to the last external address latched at the latch means by that the counted internal address moved around.

According to a third aspect of the present invention, in the second aspect, the semiconductor memory further provides a first judging means for judging that the semiconductor memory was instructed to change to the self refreshing mode, when a column address strobe (CAS) signal had been inputted before a row address strobe (RAS) signal was inputted from the outside. And when the first judging means judged that the semiconductor memory had been instructed to change to the self refreshing mode, the first judging means outputs a clock CAS before RAS (CKCBR) signal, which signifies that the self refreshing mode starts, to the latch means, the adding means, and the second counting means and also outputs a CAS before RAS (CBR) signal, which signifies that the self refreshing mode is working, to the comparing means.

According to a fourth aspect of the present invention, in the third aspect, the semiconductor memory further provides a first selecting means for selecting either the internal addresses counted at the second counting means or the external addresses inputted from the outside. And the first judging means also outputs the CBR signal, which signifies that the self refreshing mode is working, to the first selecting means, and the first selecting means selects the internal addresses, during the period that the CBR signal is inputting to the first selecting means from the first judging means.

According to a fifth aspect of the present invention, in the third aspect, the semiconductor memory further provides a first timing generating means for generating the designated timing. And the first judging means also outputs the CBR signal to the first timing generating means, and the first timing generating means outputs the generated timing to the adding means and the second counting means, during the period that the CBR signal is inputting to the first timing generating means from the first judging means.

According to a sixth aspect of the present invention, there is provided a semiconductor memory. The semiconductor memory provides a third counting means for counting internal addresses from “0” at designated timing when the semiconductor memory was instructed to change to a self refreshing mode, and a count detecting means for detecting whether the internal address counted by the third counting means became “0” again or not by that the internal address was moved around once at the third counting means. And when the internal address counted at the third counting means became “0” by the detected result at the count detecting means, the self refreshing mode is ended.

According to a seventh aspect of the present invention, in the sixth aspect, the semiconductor memory further provides a second judging means for judging that the semiconductor memory was instructed to change to the self refreshing mode, when a CAS signal had been inputted before a RAS signal was inputted from the outside. And when the second judging means judged that the semiconductor memory had been instructed to change to the self refreshing mode, the second judging means outputs a CKCBR signal, which signifies that the self refreshing mode starts, to the third counting means.

According to an eighth aspect of the present invention in the seventh aspect, the semiconductor memory further provides a second selecting means for selecting either the internal addresses counted at the third counting means or the external addresses inputted from the outside. And the second judging means also outputs the CBR signal, which signifies that the self refreshing mode is working, to the second selecting means, and the second selecting means selects the internal addresses, during the period that the CBR signal is inputting to the second selecting means from the second judging means.

According to a ninth aspect of the present invention in the seventh aspect, the semiconductor memory further provides a second timing generating means for generating the designated timing. And the second judging means also outputs the CBR signal to the second timing generating means, and the second timing generating means outputs the generated timing to the third counting means during the period that the CBR signal is inputting from the second judging means to the second timing generating means.

According to a tenth aspect of the present invention, there is provided a semiconductor memory. The semiconductor memory provides a control signal generating means for generating signals to control a self refreshing mode of the semiconductor memory, a first internal address generating means for generating internal addresses for the self refreshing mode of the semiconductor memory, and a comparing means for comparing the internal addresses generated at the internal address generating means with an external address inputted from the outside. And the control signal generating means provides a judging means for judging that the semiconductor memory was instructed to change to the self refreshing mode, when a CAS signal had been inputted before a RAS signal was inputted from the outside, and outputs a CKCBR signal, which signifies that the self refreshing mode starts, to the first internal address generating means, and also outputs a CBR signal, which signifies that the self refreshing mode is working, and a timing generating means, to which the CBR signal from the judging means is inputted, and generates timing signals with which the first internal address generating means generates timing of generating internal addresses during the period of the self refreshing mode. And the first internal address generating means provides a latch means for latching external addresses inputted from the outside, an adding means for adding “1” to a last external address in the external addresses latched at the latch means when the semiconductor memory was instructed to change to the self refreshing mode, a first counting means for counting internal addresses at the designated timing generated at the timing generating means by making the last external address added “1” be a first internal address so that the internal address moves around once, and a first selecting means that selects either the internal addresses counted at the first counting means or the external addresses inputted from the outside, and selects the internal addresses, during the period that the CBR signal is inputting to the first selecting means from the judging means. And the comparing means compares the internal addresses counted by the first counting means with the last external address latched at the latch means, and makes the self refreshing mode end, when one of the internal addresses counted by the counting means became equal to the last external address latched at the latch means by that the counted internal address moved around once.

According to an eleventh aspect of the present invention, there is provided a semiconductor memory. The semiconductor memory provides a control signal generating means for generating signals to control a self refreshing mode for the semiconductor memory, and a second internal address generating means for generating internal addresses for the self refreshing mode of the semiconductor memory. And the control signal generating means provides a judging means for judging that the semiconductor memory was instructed to change to the self refreshing mode, when a CAS signal had been inputted before a RAS signal was inputted from the outside, and outputs a CKCBR signal, which signifies that the self refreshing mode starts, to the second internal address generating means, and also outputs a CBR signal, which signifies that the self refreshing mode is working, and a timing generating means, to which the CBR signal from the judging means is inputted, and generates timing signals with which the second internal address generating means generates timing of generating internal addresses during the period of the self refreshing mode. And the second internal address generating means provides a second counting means for counting internal addresses from “0” at the designated timing when the semiconductor memory was instructed to change to the self refreshing mode, a second selecting means that selects either the internal addresses counted at the second counting means or the external addresses inputted from the outside, and selects the internal addresses, during the period that the CBR signal is inputting to the second selecting means from the judging means, and a count detecting means that detects whether one of the internal addresses counted at the second counting means became “0” again or not by that the internal address was moved around once by the second counting means, and when one of the internal addresses counted at the second counting means became “0” by the detected result at the count detecting means, the self refreshing mode is ended.

According to a twelfth aspect of the present invention, there is provided an address controlling method of a semiconductor memory. The address controlling method of the semiconductor memory provides the steps of; counting internal addresses when the semiconductor memory was instructed to change to a self refreshing mode, detecting whether the internal address moved around once or not by the counted result by the counting step, and making the self refreshing mode end when the internal address had moved around once was detected at the detecting step.

According to thirteenth aspect of the present invention, there is provided an address controlling method of a semiconductor memory. The address controlling method of the semiconductor memory provides the steps of; latching external addresses inputted from the outside when the semiconductor memory was instructed to change to a self refreshing mode, adding “1” to a last external address in the latched external addresses, counting internal addresses at designated timing by making the last external address added “1” be a first internal address so that the internal address moves around once, comparing a counted internal address with the last latched external address, and making the self refreshing mode end, when the counted internal address became equal to the last latched external address by that the counted internal address moved around.

According to a fourteenth aspect of the present invention, in the thirteenth aspect, the address controlling method of the semiconductor memory further provides the steps of; judging that the semiconductor memory was instructed to change to the self refreshing mode, when a CAS signal had been inputted before a RAS signal was inputted from the outside, and generating a CKCBR signal, which signifies that the self refreshing mode starts, and a CBR signal, which signifies that the self refreshing mode is working, when it was judged that the semiconductor memory had been instructed to change to the self refreshing mode. And the latching step and the adding step are executed by using the CKCBR signal.

According to a fifteenth aspect of the present invention, in the fourteenth aspect, the address controlling method of the semiconductor memory further provides the step of; selecting either the internal addresses counted at the counting step or the external addresses inputted from the outside. And the selecting step selects the internal addresses, during the period that the CBR signal is generating.

According to a sixteenth aspect of the present invention, in the fourteenth aspect, the address controlling method of the semiconductor memory further provides the step of; generating the designated timing during the period that the CBR signal is generating after the CKCBR signal and the CBR signal were generated. And the counting step is executed by using the generated timing.

According to a seventeenth aspect of the present invention, there is provided an address controlling method of a semiconductor memory. The address controlling method of the semiconductor memory provides the steps of; counting internal addresses from “0” at designated timing when the semiconductor memory was instructed to change to a self refreshing mode, and detecting whether the internal address counted at the counting step became “0” again or not by that the internal address was moved around once. And when the internal address counted at the counting step became “0”, the self refreshing mode is ended.

According to an eighteenth aspect of the present invention, in the seventeenth aspect, the address controlling method of the semiconductor memory further provides the steps of; judging that the semiconductor memory was instructed to change to the self refreshing mode, when a CAS signal had been inputted before a RAS signal was inputted from the outside, and generating a CKCBR signal, which signifies that the self refreshing mode starts, and a CBR signal, which signifies that the self refreshing mode is working, when it was judged that the semiconductor memory had been instructed to change to the self refreshing mode. And the counting step starts to count the internal address from“0” by that the CKCBR signal is inputted.

According to a nineteenth aspect of the present invention, in the eighteenth aspect, the address controlling method of the semiconductor memory further provides the step of; selecting either the internal addresses counted at the counting step or the external addresses inputted from the outside. And the selecting step selects the internal addresses, during the period that the CBR signal is inputting.

According to a twentieth aspect of the present invention, in the eighteenth aspect, the address controlling method of the semiconductor memory further provides the step of; generating the designated timing during the period that the CBR signal is generating after the CKCBR signal and the CBR signal were generated. And the counting step is executed by using the generated timing.

According to a twenty-first aspect of the present invention, there is provided an address controlling method of a semiconductor memory. The address controlling method of the semiconductor memory provides the steps of; judging that the semiconductor memory was instructed to change to the self refreshing mode, when a CAS signal was inputted before a RAS signal is inputted from the outside, outputting a CKCBR signal, which signifies that the self refreshing mode starts, when the CAS signal was inputted before the RAS signal is inputted from the outside, outputting a CBR signal, which signifies that the self refreshing mode is working, when the CAS signal was inputted before sasid RAS signal is inputted from the outside, generating timing signals for generating internal addresses during the period of the self refreshing mode by inputting the CBR signal, latching external addresses inputted from the outside, adding “1” to a last external address in the latched external addresses by inputting the CKCBR signal, counting internal addresses at the designated timing by making the last external address added “1” be a first internal address so that the internal address moves around once, selecting either the counted internal addresses or the external address inputted from the outside, selecting the internal addresses, during the period that the CBR signal is inputting, comparing the internal addresses with the last external address latched during the period of the self refreshing mode by inputting the CBR signal, and making the self refreshing mode end, when one of the internal addresses became equal to the last external address by that the counted internal address moved around once.

According to a twenty-second aspect of the present invention, there is provided an address controlling method of a semiconductor memory. The address controlling method of the semiconductor memory provides the steps of; judging that the semiconductor memory was instructed to change to the self refreshing mode, when a CAS signal was inputted before a RAS signal is inputted from the outside, outputting a CKCBR signal, which signifies that the self refreshing mode starts, when the CAS signal was inputted before the RAS signal is inputted from the outside, outputting a CBR signal, which signifies that the self refreshing mode is working, when the CAS signal was inputted before the RAS signal is inputted from the outside, generating timing signals for generating the internal addresses during the period of the self refreshing mode by inputting the CBR signal, counting internal addresses from “0” at the designated timing when the semiconductor memory was instructed to change to the self refreshing mode, selecting either the internal addresses or the external addresses inputted from the outside, selecting the internal addresses, during the period that the CBR signal is inputting, detecting whether one of the internal addresses became “0” again or not by that the internal address was moved around once, and making the self refreshing mode end, when one of the internal addresses became “0”.

### BRIEF DESCRIPTION OF THE DRAWINGS

The objects and features of the present invention will become more apparent from the consideration of the following detailed description taken in conjunction with the accompanying drawings in which:

FIG. 1 is a timing chart showing the operation of an internal address generating circuit of a semiconductor memory at a conventional technology;

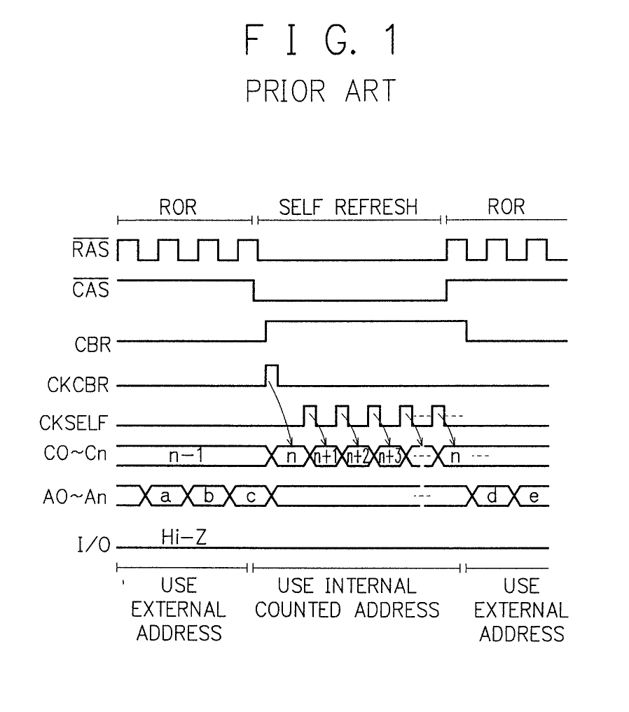

FIG. 2 is a block diagram showing a structure of a control signal generating circuit at a first embodiment of a semiconductor memory of the present invention;

FIG. 3 is a block diagram showing a structure of an internal address generating circuit and a comparator at the first embodiment of the semiconductor memory of the present invention;

FIG. 4 is a timing chart showing the operation of the first embodiment of the semiconductor memory of the present invention;

FIG. 5 is a block diagram showing a structure of an internal address generating circuit at a second embodiment of the semiconductor memory of the present invention; and

FIG. 6 is a timing chart showing the operation of the second embodiment of the semiconductor memory of the present invention.

### DESCRIPTION OF THE PREFERRED EMBODIMENTS

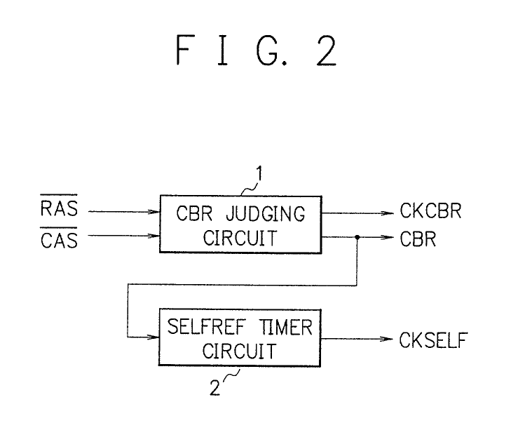

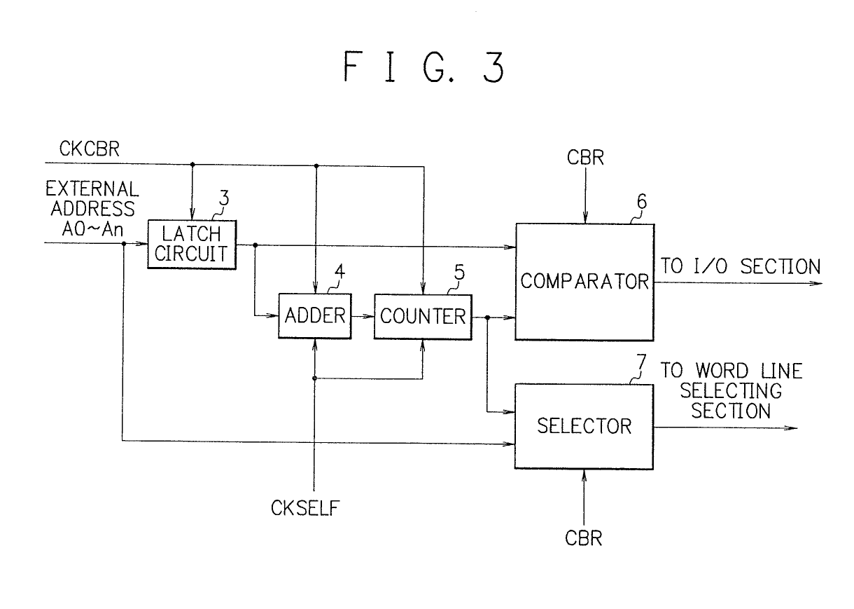

Referring now to the drawings, embodiments of the present invention are explained in detail. FIG. 2 is a block diagram showing a structure of a control signal generating circuit at a first embodiment of a semiconductor memory of the present invention. FIG. 3 is a block diagram showing a structure of an internal address generating circuit and a comparator at the first embodiment of the semiconductor memory of the present invention. As shown in FIG. 2, the control signal generating circuit of the first embodiment of the semiconductor memory of the present invention consists of a CAS before RAS (CBR) judging circuit 1, and self refreshing (SELFREF) timer circuit 2. In this, the CAS signifies a column address strobe, and the RAS signifies a row address strobe. As shown in FIG. 3, the internal address generating circuit of the first embodiment of the semiconductor memory of the present invention consists of a latch circuit 3, an adder 4, a counter 5, and a selector 7.

The CBR judging circuit 1 generates a CBR signal, which signifies that the semiconductor memory is now in a self refreshing process, and a clock CBR (CKCBR) signal, which signifies the start of the self refreshing process, by judging whether an inputted signal from a CPU (not shown) is a RAS # signal or a CAS # signal. The CBR signal generated at the CBR judging circuit 1 is inputted to the SELFREF timer circuit 2 in the control signal generating circuit shown in FIG. 2, and the comparator 6 in FIG. 3 and the selector 7 in the internal address generating circuit shown in FIG. 3. And the CKCBR signal generated at the CBR judging circuit 1 in FIG. 2 is inputted to the latch circuit 3, the adder 4, and the counter 5 in the internal address generating circuit shown in FIG. 3.

The SELFREF timer circuit 2 generates a clock self (CKSELF) signal that gives timing with which the counter 5 counts internal addresses during the self refreshing process. The SELFREF timer circuit 2 works during the period that the CBR signal, which signifies that the semiconductor memory is now in the self refreshing process, is inputting. The CKSELF signal is inputted to the adder 4 and the counter 5 in designated timing. And the address controlling is executed by the CBR signal, the CKCBR signal, and the CKSELF signal.

The latch circuit 3 always latches external addresses A0 to An form the outside CPU. When the CKCBR signal, which signifies the start of the self refreshing process, is inputted to the latch circuit 3, the latch circuit 3 stops latching the external addresses after the CKCBR signal was inputted, and keeps a state that the latch circuit 3 latched an external address right before the CKCBR signal was inputted. The latch circuit 3 outputs the latched external address to the adder 4 and the comparator 6.

The adder 4 makes the external address inputted from the latch circuit 3 “address+1”. And the adder 4 sets the address+1 in the counter 5.

The counter 5 counts up the address+1 set from the adder 4 every time when the CKSELF signal is inputted from the SELFREF timer circuit 2. In this, a counter that counts down the address can be used as the counter 5. The counter 5 sequentially outputs counted internal addresses C0 to Cn to the comparator 6 and the selector 7.

The comparator 6 compares the external address, latched at the latch circuit 3 and inputted from the latch circuit 3, with the internal addresses inputted from the counter 5, and when the compared result is equal, the comparator 6 outputs “1” to an input/output (I/O) section (not shown). The comparator 6 executes this comparison during the period that the CBR signal is inputting.

The external addresses A0 to An from the outside CPU and the internal addresses C0 to Cn from the counter 5 are inputted to the selector 7. The selector 7 outputs the internal addresses during the period that the CBR signal, which signifies that the semiconductor memory is now in the self refreshing process, is inputted from the CBR judging section 1, and outputs the external addresses during the other periods to a word line selecting section (not shown).

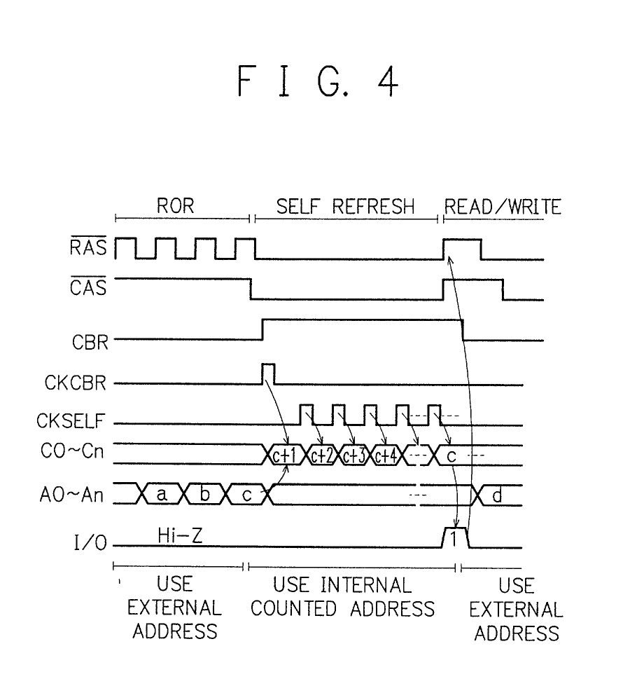

FIG. 4 is a timing chart showing the operation of the first embodiment of the semiconductor memory of the present invention. Referring to FIGS. 2 to 4, the operation of the first embodiment of the semiconductor memory of the present invention is explained. A row address is taken at the timing of a RAS # signal, and a column address is taken at the timing of a CAS # signal. The RAS # signal and the CAS # signal are controlled by the CPU.

During the period of a ROR process, external addresses A0 to An are taken every down edge input of the RAS # signals. In FIG. 4, an address ( a), an address (b), and an address (c) are taken at the timing of the down edge input of the RAS # signals.

When the down edge of a CAS # signal was inputted before the down edge of the RAS # signal is inputted, the period of the ROR process is changed to a self refreshing process and this state is kept.

When the CBR judging circuit 1 judges that the process was changed to the self refreshing process from the ROR process by the input timing of the CAS # signal and the RAS # signal, the CBR judging circuit 1 outputs a CKCBR signal to the latch circuit 3, the adder 4, and the counter 5. The latch circuit 3 latches the external address (c) right before the mode is changed to the self refreshing mode and at the same time outputs the address (c) to the adder 4.

When the CKCBR signal is inputted to the adder 4, the adder 4 adds+1 to the external address (c) set from the latch circuit 3, and sets the added address (c+1) to the counter 5.

The counter 5 starts internal counting from the address (c+1) for the self refreshing process. The counter 5 counts up every input of the CKSELF signal so that the address becomes an address (c+2), an address (c+3), an address (c+4) . . . When the address in the counter 5 moved around once and became the address (c) being right before the process was changed to the self refreshing process, the I/O section outputs “1” to the CPU. During the period of the self refreshing process, the I/O section has high impedance.

The CPU stops the self refreshing process by recognizing the “1” outputted from the I/O section. With this, all the word lines are equally refreshed.

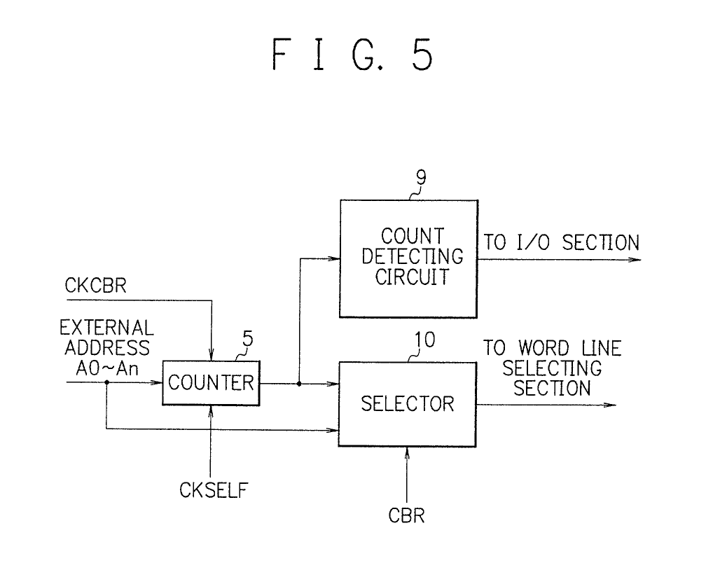

Next, referring to drawings, a second embodiment of the present invention is explained. FIG. 5 is a block diagram showing a structure of an internal address generating circuit at the second embodiment of the semiconductor memory of the present invention. The internal address generating circuit of the second embodiment of the semiconductor memory of the present invention consists of a counter 8, a count detecting circuit 9, and a selector 10.

At the second embodiment, the control signal generating circuit is the same as the first embodiment shown in FIG. 2, and as mentioned above, the internal address generating circuit is different form the first embodiment, and the comparator 6 at the first embodiment shown in FIG. 3 is not used.

External addresses A0 to An are set to the counter 8, and when the CKCBR signal is inputted to the counter 8, the internal address (value) in the counter 8 is reset, for example, to “0”. And the counter 8 counts up the internal address (value) every input of the CKSELF signal outputted from the SELFREF timer circuit 2. In this, a counter that counts down the value can be used as the counter 8. The counter 8 outputs counted internal addresses CO to Cn to the count detecting circuit 9 and the selector 10.

The count detecting circuit 9 outputs “1” to the CPU from the I/O section, when the internal address in the counter 8 moved around once. That is, at the case that the counter 8 started to count from “0”, and when the internal address (value) in the counter 8 became “0” again, the “1” is outputted to the CPU from the I/O section.

The external addresses A0 to An from the outside CPU and the internal addresses C0 to Cn from the counter 8 are inputted to the selector 10. The selector 10 outputs the internal addresses during the period that the CBR signal, which signifies that the semiconductor memory is now in the self refreshing process, is being inputted from the CBR judging section 1, and outputs the external addresses during the other periods to the word line selecting section (actual address section).

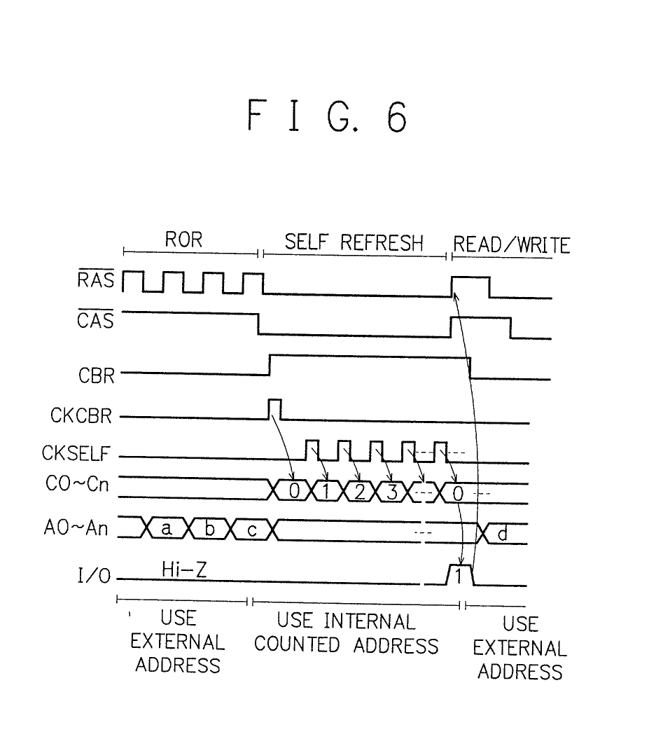

FIG. 6 is a timing chart showing the operation of the second embodiment of the semiconductor memory of the present invention. Referring to FIGS. 5 and 6, the operation of the second embodiment of the semiconductor memory of the present invention is explained.

During the period of a ROR process, external addresses A0 to An are taken every down edge input of RAS # signals. In FIG. 6, an address (a), an address (b), and an address (c) are taken at the timing of the down edge input of the RAS # signals.

When the down edge of a CAS # signal was inputted before the down edge of the RAS # signal is inputted, the process of the ROR is changed to a self refreshing process and this state is kept.

When the CBR judging circuit 1 judges that the process is changed to the self refreshing process from the ROR process by the input timing of the CAS # signal and the RAS # signal, the CBR judging circuit 1 outputs a CKCBR signal to the counter 8. When the CKCBR signal is inputted to the counter 8, the counter 8 initializes the internal address (value) in the counter 8. In FIG. 6, the value is initialized to “0”. The counter 8 counts up the internal address every input of the CKSELF signal so that the internal address becomes an address (1), an address (2), an address (3) . . . When the internal address in the counter 8 moved around once and became the address (0) being the initialized value again, the I/O section outputs “1” to the CPU. During the period of the self refreshing process, the I/O section has high impedance.

The CPU stops the self refreshing mode by recognizing the “1” outputted from the I/O section. With this, all the word lines are equally refreshed.

And also at the second embodiment of the present invention, the count detecting circuit 9 detects that the counter 8 moved around once, therefore all the word lines are refreshed equally. However, for example, the external address at the time when the period of the ROR process finished is “0”, that is, at the case that the address (c) is “0”, when the mode is changed to the self refreshing mode, the internal address starts from “0”, therefore the hold time of the other word lines becomes long a little.

As mentioned above, at the internal address controlling circuit for the semiconductor memory at the Japanese Patent Application Laid-Open No. HEI 11-242884, only when the discontinuity of address occurs at the address counter, the self refreshing process is started. However, at the present invention, the self refreshing process is started by self refreshing mode changing signals being the RAS # signal and the CAS # signal from the CPU, and at the time after that the self refreshing process worked around once the semiconductor memory, a signal signifying that the self refreshing process finished is outputted from the I/O section to the CPU.

As mentioned above, according to the present invention, first an external address is latched as a reference address, and an internal counter counts up until an internal address becomes the reference address again, that is, until the internal counter is moved around once, therefore all the word lines are refreshed equally, and it becomes unnecessary that an ROR process being a centralized refreshing process is executed again after the self refreshment process.

Further, according to the present invention, the ROR process being the centralized refreshing process after the self refreshment process is not required again, therefore the power consumption at the ROR process being the centralized refreshing process after the self refreshing process can be saved.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A semiconductor memory, comprising:
a first counting means for counting internal addresses when said semiconductor memory was instructed to change to a self refreshing mode; and
an internal address detecting means for detecting whether said internal address moved around once or not by the counted result at said first counting means, wherein:
said internal address detecting means makes said self refreshing mode end when said internal address detecting means detected that said internal address had moved around once by said counted result at said first counting means.

2. A semiconductor memory, comprising:
a latch means for latching external addresses inputted from the outside when said semiconductor memory was instructed to change to a self refreshing mode;
an adding means for adding “1” to a last external address in said external addresses latched at said latch means;
a second counting means for counting internal addresses at designated timing by making said last external address added “1” be a first internal address so that said internal address moves around once; and
a comparing means for comparing said internal addresses counted by said second counting means with said last external address latched at said latch means, wherein:
said comparing means makes said self refreshing mode end, when one of said internal addresses counted by said second counting means became equal to said last external address latched at said latch means by that said counted internal address moved around.

3. A semiconductor memory in accordance with claim 2, further comprising:
a first judging means for judging that said semiconductor memory was instructed to change to said self refreshing mode, when a column address strobe (CAS) signal had been inputted before a row address strobe (RAS) signal was inputted from the outside, wherein:
when said first judging means judged that said semiconductor memory had been instructed to change to said self refreshing mode,
said first judging means outputs a clock CAS before RAS (CKCBR) signal, which signifies that said self refreshing mode starts, to said latch means, said adding means, and said second counting means and also outputs a CAS before RAS (CBR) signal, which signifies that said self refreshing mode is working, to said comparing means.

4. A semiconductor memory in accordance with claim 3, further comprising:
a first selecting means for selecting either said internal addresses counted at said second counting means or said external addresses inputted from the outside, wherein:
said first judging means also outputs said CBR signal, which signifies that said self refreshing mode is working, to said first selecting means, and
said first selecting means selects said internal addresses, during the period that said CBR signal is inputting to said first selecting means from said first judging means.

5. A semiconductor memory in accordance with claim 3, further comprising:
a first timing generating means for generating said designated timing, wherein:
said first judging means also outputs said CBR signal to said first timing generating means, and
said first timing generating means outputs said generated timing to said adding means and said second counting means, during the period that said CBR signal is inputting to said first timing generating means from said first judging means.

6. A semiconductor memory, comprising:
a third counting means for counting internal addresses from “0” at designated timing when said semiconductor memory was instructed to change to a self refreshing mode; and
a count detecting means for detecting whether said internal address counted by said third counting means became “0 ” again or not by that said internal address was moved around once at said third counting means, wherein:
when said internal address counted at said third counting means became “0” by the detected result at said count detecting means, said self refreshing mode is ended.

7. A semiconductor memory in accordance with claim 6, further comprising:
a second judging means for judging that said semiconductor memory was instructed to change to said self refreshing mode, when a CAS signal had been inputted before a RAS signal was inputted from the outside, wherein:
when said second judging means judged that said semiconductor memory had been instructed to change to said self refreshing mode,
said second judging means outputs a CKCBR signal, which signifies that said self refreshing mode starts, to said third counting means.

8. A semiconductor memory in accordance with claim 7, further comprising:
a second selecting means for selecting either said internal addresses counted at said third counting means or said external addresses inputted from the outside, wherein:
said second judging means also outputs said CBR signal, which signifies that said self refreshing mode is working, to said second selecting means, and
said second selecting means selects said internal addresses, during the period that said CBR signal is inputting to said second selecting means from said second judging means.

9. A semiconductor memory in accordance with claim 7, further comprising:
a second timing generating means for generating said designated timing, wherein:
said second judging means also outputs said CBR signal to said second timing generating means, and
said second timing generating means outputs said generated timing to said third counting means during the period that said CBR signal is inputting from said second judging means to said second timing generating means.

10. A semiconductor memory, comprising:
a control signal generating means for generating signals to control a self refreshing mode of said semiconductor memory;
a first internal address generating means for generating internal addresses for said self refreshing mode of said semiconductor memory; and
a comparing means for comparing said internal addresses generated at said internal address generating means with an external address inputted from the outside, wherein:
said control signal generating means, comprising:
a judging means for judging that said semiconductor memory was instructed to change to said self refreshing mode, when a CAS signal had been inputted before a RAS signal was inputted from the outside, and outputs a CKCBR signal, which signifies that said self refreshing mode starts, to said first internal address generating means, and also outputs a CBR signal, which signifies that said self refreshing mode is working; and
a timing generating means, to which said CBR signal from said judging means is inputted, and generates timing signals with which said first internal address generating means generates timing of generating internal addresses during the period of said self refreshing mode, and
said first internal address generating means, comprising:
a latch means for latching external addresses inputted from the outside;
an adding means for adding “1” to a last external address in said external addresses latched at said latch means when said semiconductor memory was instructed to change to said self refreshing mode;
a first counting means for counting internal addresses at said designated timing generated at said timing generating means by making said last external address added “1” be a first internal address so that said internal address moves around once; and
a first selecting means that selects either said internal addresses counted at said first counting means or said external addresses inputted from the outside, and selects said internal addresses, during the period that said CBR signal is inputting to said first selecting means from said judging means, and wherein:
said comparing means compares said internal addresses counted by said first counting means with said last external address latched at said latch means, and makes said self refreshing mode end, when one of said internal addresses counted by said counting means became equal to said last external address latched at said latch means by that said counted internal address moved around once.

11. A semiconductor memory, comprising:
a control signal generating means for generating signals to control a self refreshing mode for said semiconductor memory; and
a second internal address generating means for generating internal addresses for said self refreshing mode of said semiconductor memory, and
said control signal generating means, comprising:
a judging means for judging that said semiconductor memory was instructed to change to said self refreshing mode, when a CAS signal had been inputted before a RAS signal was inputted from the outside, and outputs a CKCBR signal, which signifies that said self refreshing mode starts, to said second internal address generating means, and also outputs a CBR signal, which signifies that said self refreshing mode is working; and
a timing generating means, to which said CBR signal from said judging means is inputted, and generates timing signals with which said second internal address generating means generates timing of generating internal addresses during the period of said self refreshing mode, and
said second internal address generating means, comprising:
a second counting means for counting internal addresses from “0” at said designated timing when said semiconductor memory was instructed to change to said self refreshing mode;
a second selecting means that selects either said internal addresses counted at said second counting means or said external addresses inputted from the outside, and selects said internal addresses, during the period that said CBR signal is inputting to said second selecting means from said judging means; and
a count detecting means that detects whether one of said internal addresses counted at said second counting means became “0” again or not by that said internal address was moved around once by said second counting means, and wherein:
when one of said internal addresses counted at said second counting means became “0” by the detected result at said count detecting means, said self refreshing mode is ended.

12. An address controlling method of a semiconductor memory, comprising the steps of:
counting internal addresses when said semiconductor memory was instructed to change to a self refreshing mode;
detecting whether said internal address moved around once or not by the counted result by said counting step; and
making said self refreshing mode end when said internal address had moved around once was detected at said detecting step.

13. An address controlling method of a semiconductor memory, comprising the steps of:
latching external addresses inputted from the outside when said semiconductor memory was instructed to change to a self refreshing mode;
adding “1” to a last external address in said latched external addresses;
counting internal addresses at designated timing by making said last external address added “1” be a first internal address so that said internal address moves around once;
comparing a counted internal address with said last latched external address; and
making said self refreshing mode end, when said counted internal address became equal to said last latched external address by that said counted internal address moved around.

14. An address controlling method of a semiconductor memory in accordance with claim 13, further comprising the steps of:
judging that said semiconductor memory was instructed to change to said self refreshing mode, when a CAS signal had been inputted before a RAS signal was inputted from the outside; and
generating a CKCBR signal, which signifies that said self refreshing mode starts, and a CBR signal, which signifies that said self refreshing mode is working, when it was judged that said semiconductor memory had been instructed to change to said self refreshing mode, wherein:
said latching step and said adding step are executed by using said CKCBR signal.

15. An address controlling method of a semiconductor memory in accordance with claim 14, further comprising the step of:
selecting either said internal addresses counted at said counting step or said external addresses inputted from the outside, wherein:
said selecting step selects said internal addresses, during the period that said CBR signal is generating.

16. An address controlling method of a semiconductor memory in accordance with claim 14, further comprising the step of:
generating said designated timing during the period that said CBR signal is generating after said CKCBR signal and said CBR signal were generated, wherein:
said counting step is executed by using said generated timing.

17. An address controlling method of a semiconductor memory, comprising the steps of:
counting internal addresses from “0” at designated timing when said semiconductor memory was instructed to change to a self refreshing mode; and
detecting whether said internal address counted at said counting step became “0” again or not by that said internal address was moved around once, wherein:
when said internal address counted at said counting step became “0”, said self refreshing mode is ended.

18. An address controlling method of a semiconductor memory in accordance with claim 17, further comprising the steps of:
judging that said semiconductor memory was instructed to change to said self refreshing mode, when a CAS signal had been inputted before a RAS signal was inputted from the outside; and
generating a CKCBR signal, which signifies that said self refreshing mode starts, and a CBR signal, which signifies that said self refreshing mode is working, when it was judged that said semiconductor memory had been instructed to change to said self refreshing mode, wherein:
said counting step starts to count said internal address from “0” by that said CKCBR signal is inputted.

19. An address controlling method of a semiconductor memory in accordance with claim 18, further comprising the step of:
selecting either said internal addresses counted at said counting step or said external addresses inputted from the outside, wherein:
said selecting step selects said internal addresses, during the period that said CBR signal is inputting.

20. An address controlling method of a semiconductor memory in accordance with claim 18, further comprising the step of:
generating said designated timing during the period that said CBR signal is generating after said CKCBR signal and said CBR signal were generated, wherein:
said counting step is executed by using said generated timing.

21. An address controlling method of a semiconductor memory, comprising the steps of:
judging that said semiconductor memory was instructed to change to said self refreshing mode, when a CAS signal was inputted before a RAS signal is inputted from the outside;
outputting a CKCBR signal, which signifies that said self refreshing mode starts, when said CAS signal was inputted before said RAS signal is inputted from the outside;
outputting a CBR signal, which signifies that said self refreshing mode is working, when said CAS signal was inputted before said RAS signal is inputted from the outside;
generating timing signals for generating internal addresses during the period of said self refreshing mode by inputting said CBR signal;
latching external addresses inputted from the outside;
adding “1” to a last external address in said latched external addresses by inputting said CKCBR signal;
counting internal addresses at said designated timing by making said last external address added “1” be a first internal address so that said internal address moves around once;
selecting either said counted internal addresses or said external address inputted from the outside;
selecting said internal addresses, during the period that said CBR signal is inputting;
comparing said internal addresses with said last external address latched during the period of said self refreshing mode by inputting said CBR signal; and
making said self refreshing mode end, when one of said internal addresses became equal to said last external address by that said counted internal address moved around once.

22. An address controlling method of a semiconductor memory, comprising the steps of:
judging that said semiconductor memory was instructed to change to said self refreshing mode, when a CAS signal was inputted before a RAS signal is inputted from the outside;
outputting a CKCBR signal, which signifies that said self refreshing mode starts, when said CAS signal was inputted before said RAS signal is inputted from the outside;
outputting a CBR signal, which signifies that said self refreshing mode is working, when said CAS signal was inputted before said RAS signal is inputted from the outside;
generating timing signals for generating said internal addresses during the period of said self refreshing mode by inputting said CBR signal;
counting internal addresses from “0” at said designated timing when said semiconductor memory was instructed to change to said self refreshing mode;
selecting either said internal addresses or said external addresses inputted from the outside;
selecting said internal addresses, during the period that said CBR signal is inputting;
detecting whether one of said internal addresses became “0” again or not by that said internal address was moved around once; and
making said self refreshing mode end, when one of said internal addresses became “0”.
